(19) United States
(12) Patent Application Publication
(10) Pub. No.: US 2008/0104396 A1
(43) Pub. Date: May 1, 2008

(54) Authentication Method

(76) Inventors: Tomoya Sato, Nara (JP); Makoto Fujiwara, Kyoto (JP)

Correspondence Address: MCDERMOTT WILL & EMERY LLP, 600 13TH STREET, NW, WASHINGTON, DC, 20005-3096, US

(21) Appl. No.: 11/666,142

(22) PCT Filed: Oct. 21, 2005
(86) PCT No.: PCT/JP05/19407

§ 371 Date: Apr. 23, 2007

(30) Foreign Application Priority Data
Oct. 25, 2004 (JP) 2004-309407

(51) Int. Cl. H04L 9/32

(52) U.S. Cl. 713/168

(57) ABSTRACT

In an authentication method which carries out two-stage authentication operation processing constituted with a first authentication operation processing and a second authentication processing, authentication becomes authorized illegally if the same key as that of the first authentication operation processing is given to the second authentication processing.

[MEANS FOR SOLVING PROBLEMS] Whether the authentication operation processing in action is the first authentication operation processing or the second authentication operation processing is clearly distinguished through judging the number of necessary authentication times and judging what number of the authentication operation processing the one under action is. Further, the values of each authentication intermediate key generated in the two-stage authentication operation processing are compared through a comparing circuit. When the values are identical, the host apparatus judges the authentication between the target apparatus as a failure considering that unlawful authentication processing is executed.

### TECHNICAL FIELD

The present invention relates to an authentication method carried out between a target apparatus and a host apparatus when the host apparatus handles secret information that is stored inside the target apparatus.

### BACKGROUND ART

In a target apparatus storing contents such as pieces of work and personal information which need to be protected from being illegally copied or leaked to the outside, the contents are stored in a state of being encrypted. When a host apparatus handles the encrypted contents stored in the target apparatus, authentication processing is carried out between the target apparatus and the host apparatus. It is structured in such a manner that, if the authentication is failed, the host apparatus cannot obtain a contents key from the target apparatus for decrypting the encrypted contents. This structure prevents the encrypted contents from being decrypted by unauthorized host apparatuses. The target apparatus is, for example, a memory card such as an SD card. The host apparatus means a semiconductor integrated circuit that reads out data from a memory card or a set apparatus to which the semiconductor integrated circuit is mounted. Further, it means a content distributing apparatus that distributes the contents to the target apparatus.

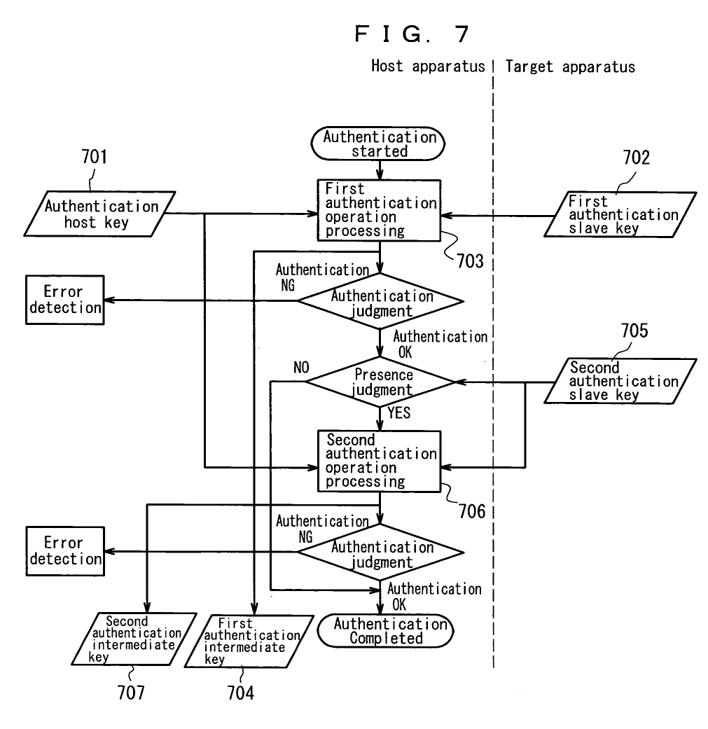

There is disclosed Patent Literature 1 as a conventional technique regarding an authentication method. Patent Literature 1 has such a feature that the authentication processing is carried out by two-stage authentication that is constituted with first authentication operation processing and second authentication operation processing. FIG. 7 shows a flowchart of the authentication method carried out between a target apparatus and a host apparatus, which is described in Patent Literature 1.

The second authentication operation processing is an extended processing that is carried out after the first authentication operation processing in order that the authentication between the target apparatus having the information of the deciphered authentication host key and the host apparatus having the deciphered authentication host key is failed at last, when the authentication host key is violated and authentication is illegally succeeded in the first authentication operation processing. That is, even if the authentication in the first authentication operation processing is illegally succeeded, it is possible to invalidate the use of the host apparatus that has the violated authentication key through the extended processing. A second authentication slave key used for the second authentication operation processing is mounted to the target apparatus through electronic distribution via a network or the like, when it is found out that the authentication host key is leaked and the first authentication operation processing is broken through. That is, when the second authentication slave key in not mounted inside the target apparatus, it means that the first authentication operation processing is not broken through. Therefore, it is not necessary to carry out the second authentication operation processing.

The flowchart of the authentication method will be described referring to FIG. 7. First, the host apparatus executes first authentication operation processing 703, through handling an authentication host key 701 provided to the host apparatus and a first authentication slave key 702 read out from the target apparatus as the input. The first authentication operation processing 703 is the processing constituted with a plurality of functions including a one-way function. It is the processing where a first authentication intermediate key 704 is generated when the authentication is succeeded, and a value “0” is generated when the authentication is failed. When the first authentication operation processing 703 is ended, the generated first authentication intermediate key 704 or the value “0” is stored in the authentication intermediate key storage area in the host apparatus, and the authentication judgment is carried out. In the authentication judgment, it is judged whether or not the output of the first authentication operation processing is “0”. When it is judged as “0”, the host apparatus considers that it is an unlawful access and unauthorizes the authentication, and discontinues the subsequent processing.

Upon succeeding the first authentication operation processing 703, the host apparatus judges whether or not there is a second authentication slave key 705 within the target apparatus. When there is the second authentication slave key 705, it is stored in advance in a prescribed area of the target apparatus.

When there is no second authentication slave key 705 inside the target apparatus, authentication is ended since it is not necessary to carry out second authentication processing 706. When the second authentication slave key 705 is present within the target apparatus, it is read out from the target apparatus and the second authentication operation processing 706 is carried out. The second authentication operation processing 706 is the processing constituted with a plurality of functions including a one-way function. It is the processing where a second authentication intermediate key 707 is generated when the authentication is succeeded, and a value “0” is generated when the authentication is failed. The second authentication operation processing 706 is also the processing which, does not authorize the authentication between the violated authentication host key and the second authentication slave key provided anew in the target apparatus, when the authentication host key is violated and authorizes the authentication between another authentication key that is not violated and the second authentication slave key. In other words, when the authentication key is violated, the second authentication slave key that satisfies the above-described condition is generated and stored inside the target apparatus.

When the second authentication operation processing 706 is ended, the generated second authentication intermediate key or the value “0” is stored in the authentication intermediate key storage area, and the authentication judgment is carried out. When it is judged as “0”, the host apparatus considers that it is an unlawful access and unauthorizes the authentication, and discontinues the subsequent processing. The authentication slave key as the source for generating the second authentication intermediate key 707 is different from that of the first authentication intermediate key 704, so that the value thereof should be different from that of the first authentication intermediate key 704.

When the authentication host key is violated, the second authentication slave key is formed anew if there is no second authentication slave key within the target apparatus, and the value of the second authentication slave key is updated if the second authentication slave key exists already within the target apparatus. New formation or update of the second authentication slave key is performed through the electronic distribution or the like. The value of the second authentication intermediate key generated by the second authentication operation processing is updated, and the authentication processing between the host apparatus having the violated authentication host key and the target apparatus having a newly formed or updated authentication slave key is unauthorized. Herewith, it can be invalidated to use the host apparatus that has the violated authentication host key.

The encrypted contents key that is already provided in the target apparatus is encrypted with the first authentication intermediate key or the second authentication intermediate key before being updated. Therefore, the contents key is re-encrypted with another second authentication intermediate key whose value is updated.

When the authentication between the target apparatus and the host apparatus is succeeded, the host apparatus reads out the encrypted contents key and the encrypted contents from the target apparatus, and decrypts the encrypted contents. Alternatively, the host apparatus encrypts the contents and the contents key, and transfers those to the target apparatus.

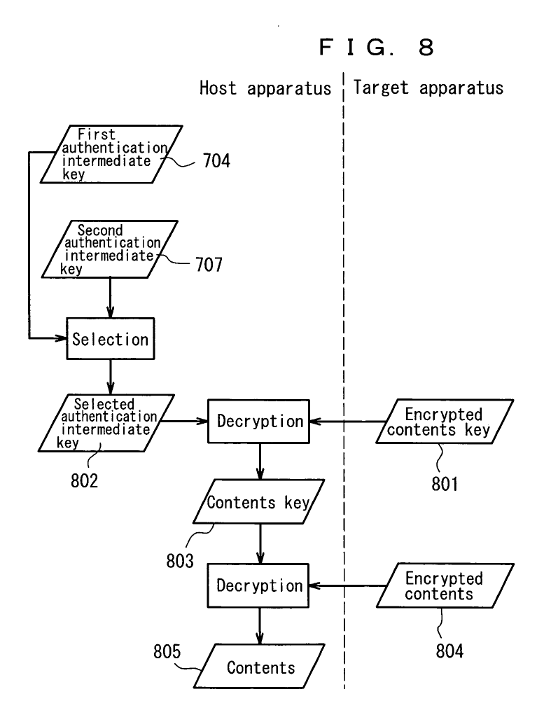

FIG. 8 shows a flowchart of a decryption method of encrypted contents, which is declared in Patent Literature 1. In FIG. 8, the same reference numerals are applied to the same structural elements as those of FIG. 7, and the descriptions thereof are omitted. The host apparatus reads out an encrypted contents key 801 that is encrypted with the first authentication intermediate key 704 or the second authentication intermediate key 707, from the target apparatus. When a second authentication intermediate key 707 is generated, the host apparatus selects the second authentication intermediate key 707 as a selected authentication key 802 and, if not, selects the first authentication intermediate key 704 as the selected authentication intermediate key 802. Then, the read out encrypted contents key 801 is decrypted with the selected authentication intermediate key 802 in order to obtain plain contents key 803. The host apparatus reads out the encrypted contents 804 encrypted with the contents key 803 from the target apparatus, and decrypts it with the contents key 803 in order to obtain plain contents 805.

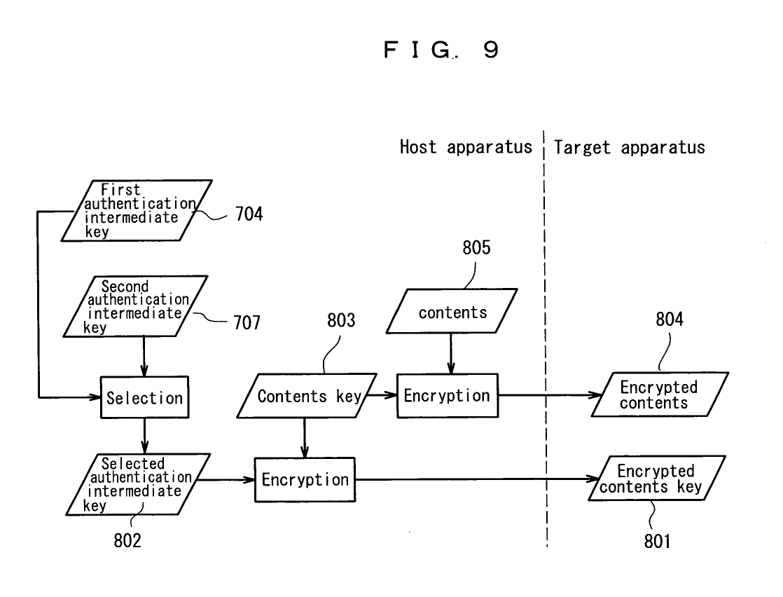

FIG. 9 shows a flowchart of contents encryption method that is declared in Patent Literature 1. In FIG. 9, the same reference numerals are applied to the same structural elements as those of FIG. 7 and FIG. 8, and the descriptions thereof are omitted. The host apparatus generates the encrypted contents 804 by encrypting the contents 805 with the contents key 803, and transfers it to the target apparatus. When the second authentication intermediate key 707 is generated, the host apparatus selects the second authentication intermediate key 707 as the selected authentication key 802 and, if not, selects the first authentication intermediate key 704 as the selected authentication intermediate key 802. Then, the contents key 803 is encrypted with the selected authentication intermediate key 802 in order to generate the encrypted contents key 801, and transfers it to the target apparatus.

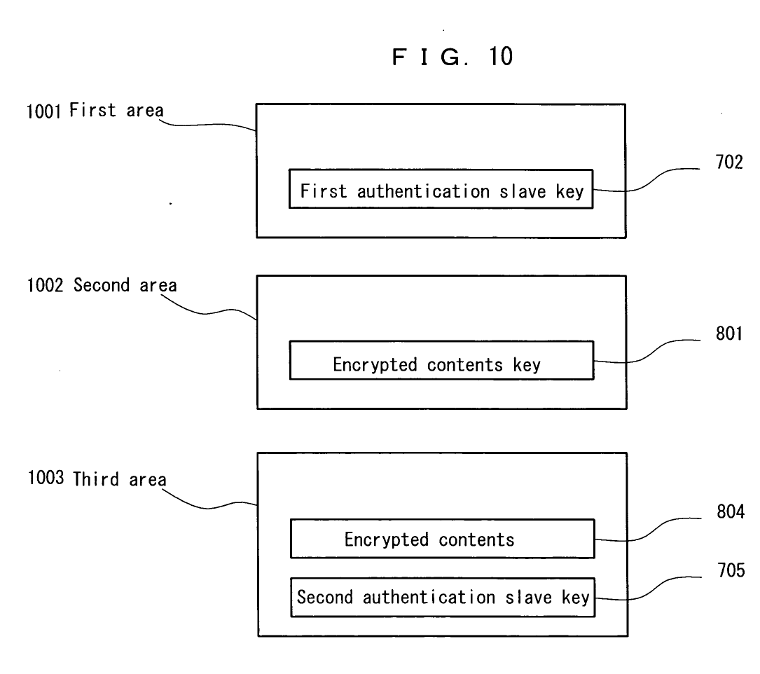

FIG. 10 shows the areas within the target apparatus and the data that is stored in each area. In FIG. 10, the same reference numerals are applied to the same structural elements as those of FIG. 7-FIG. 9, and the descriptions thereof are omitted.

For the data of the target apparatus side used in authentication and encryption/decryption of the contents, there are three areas consisting of a first area 1001, a second area 1002, and a third area 1003 as the areas for storing the data within the target apparatus. The first area 1001 is an area to be accessed in executing authentication between the target apparatus and the host apparatus, and the first authentication slave key 702 is stored therein. The second area 1002 is an area that can be accessed only when the authentication between the host apparatus and the target apparatus is succeeded, and the encrypted contents key 801 is stored therein. The third area 1003 is an area to which a user can make an access freely, and the encrypted contents 804 and the second authentication slave key 705 are stored therein.
Patent Literature 1: Japanese Unexamined Patent Publication 2000-357126

### DISCLOSURE OF THE INVENTION

### Problem to be Solved by the Invention

According to the authentication method of Patent Literature 1, when the authentication host key is violated, authentication between the target apparatus having the information of the deciphered authentication host key and the host apparatus having the deciphered authentication host key is driven into failure. Whereby, the use of the host apparatus having the violated authentication host key can be invalidated through the second authentication operation processing that is the extended processing carried out after the first authentication operation processing.

However, in the case where not the second authentication slave key that has to be fundamentally used but the first authentication slave key is given to the second authentication operation processing, the second authentication operation processing generates a key having the same value as that of the first authentication intermediate key generated in the first authentication operation processing as the second authentication intermediate key, if the authentication algorithm is the same as that of the first authentication operation processing. Since the second authentication operation processing is executed only when the authentication in the first authentication operation processing is succeeded, the value of the first authentication intermediate key is not “0”. Therefore, the value of the second authentication intermediate key is also not “0”, and the host apparatus judges that the authentication in the second authentication operation processing is succeeded. Even though the authentication in the second authentication operation processing is supposed to be failed, authentication is succeeded in the host apparatus that has the violated authentication host key. As a result, there has been such a problem that an unlawful access made by the host apparatus having the violated authentication host key is permitted.

Further, when the authentication host key is violated, the encrypted contents that is already provided in the target apparatus is necessary to be re-encrypted with another second authentication intermediate key with the updated value. However, when not the second authentication slave key that is supposed to be used but the first authentication slave key is given to the second authentication operation processing, the second authentication operation processing generates a key having the same value as that of the first authentication intermediate key generated in the first authentication operation processing, as the second authentication intermediate key. It is possible that the selected authentication intermediate key that is the key before the re-encryption and another second authentication intermediate key that is the key after the re-encryption become identical. Therefore, there has been a problem that re-encryption of the encrypted contents key cannot be achieved safely.

Furthermore, there has been also a problem that a mechanism for securely executing the necessary number of times of the authentication is not mounted.

### Means for Solving the Problems

The authentication method of the present invention comprises a device for counting the number of necessary authentication times, and counting what round of authentication operation processing it is under execution of authentication operation processing. Herewith, it is clearly distinguished whether the authentication operation processing in action is the first authentication operation processing or the second authentication operation processing. Further, when the processing in action is defined as the second authentication operation processing, it is then clearly distinguished what round of the second authentication operation processing it is under execution of authentication operation processing.

Furthermore, when it is the second authentication operation processing, the second authentication intermediate key generated anew and the authentication intermediate key generated in the previous authentication operation processing are compared with a key comparing circuit. When the two values are identical as a result of comparison, the host apparatus considers that unlawful authentication processing is executed and judges the authentication between the target apparatus as a failure.

### EFFECTS OF THE INVENTION

According to the present invention, it is possible to perform the necessary number of times of the authentication securely, and to prevent an unlawful access made by a host apparatus that has a violated authentication host key.

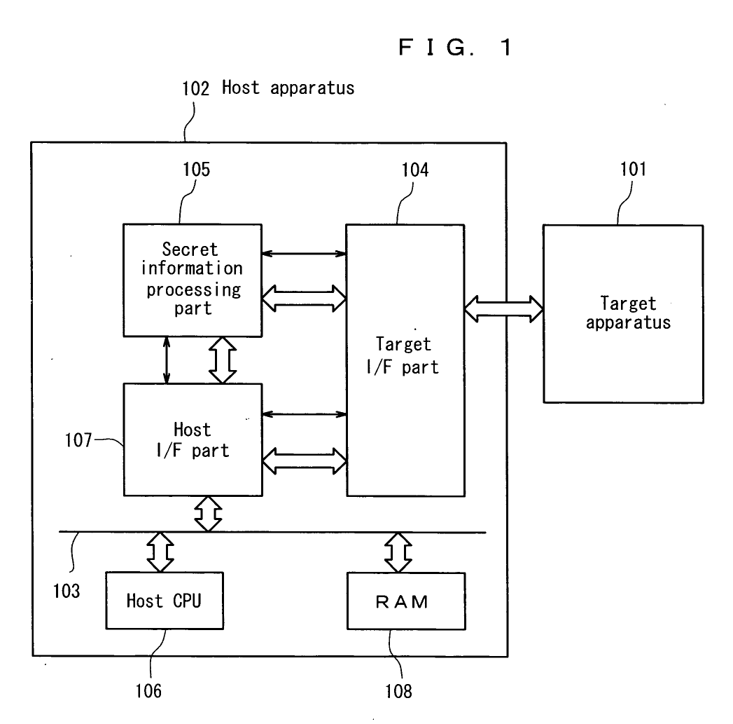

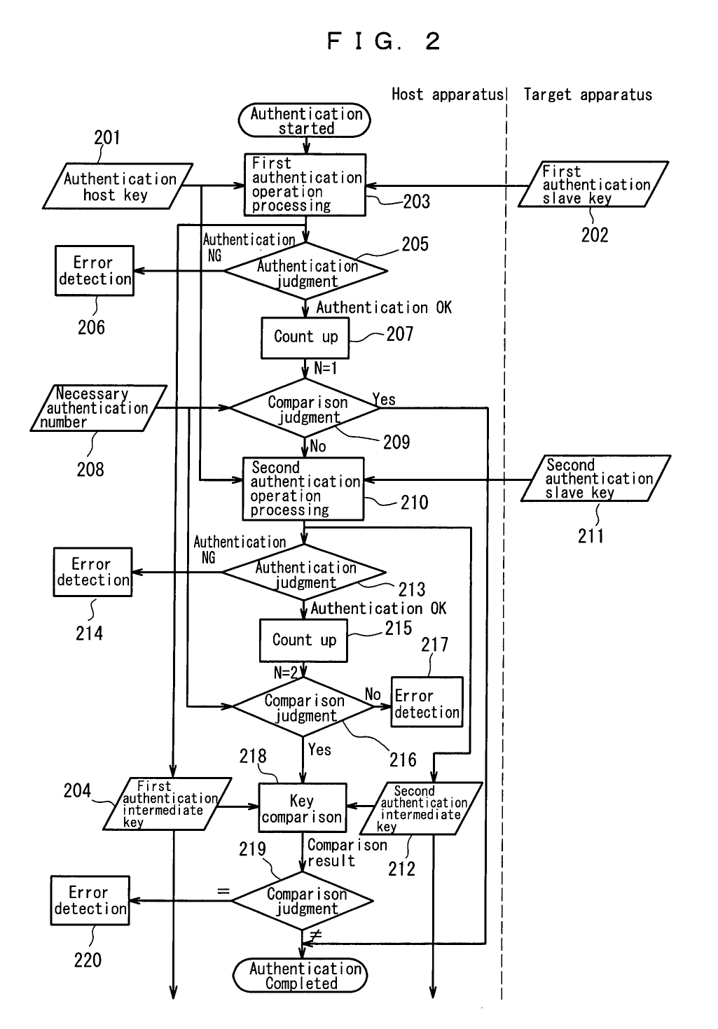

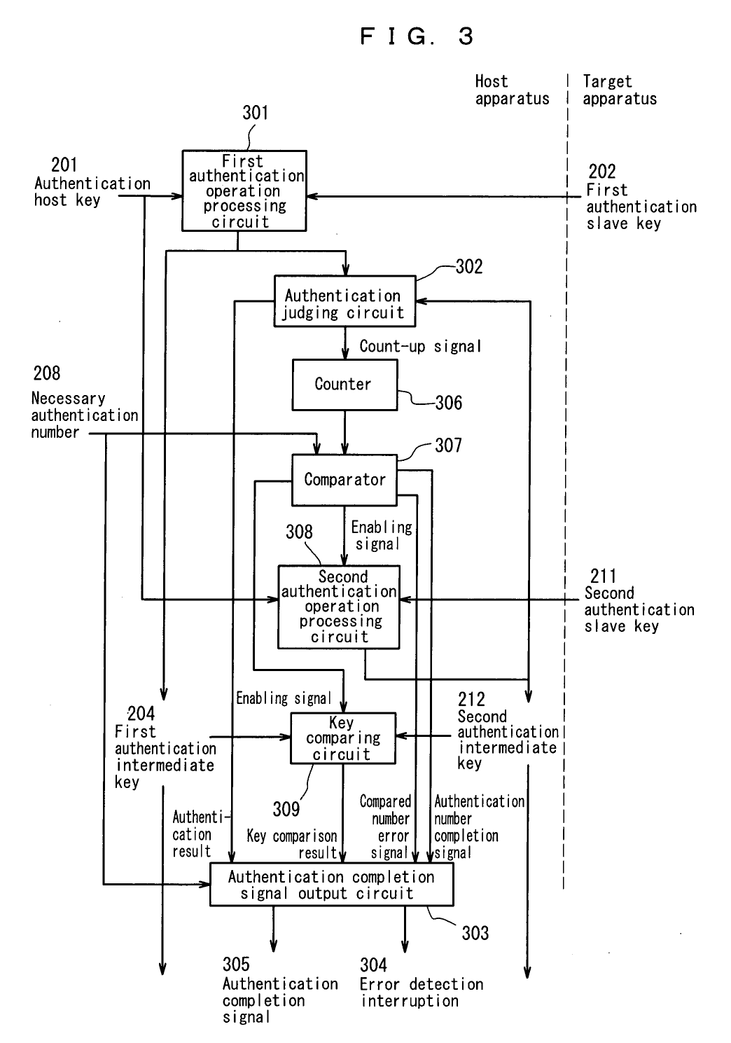

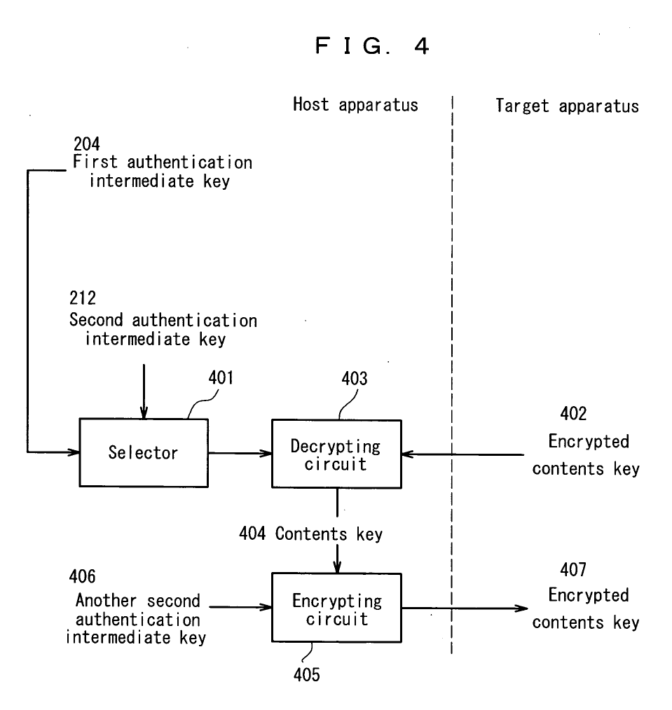

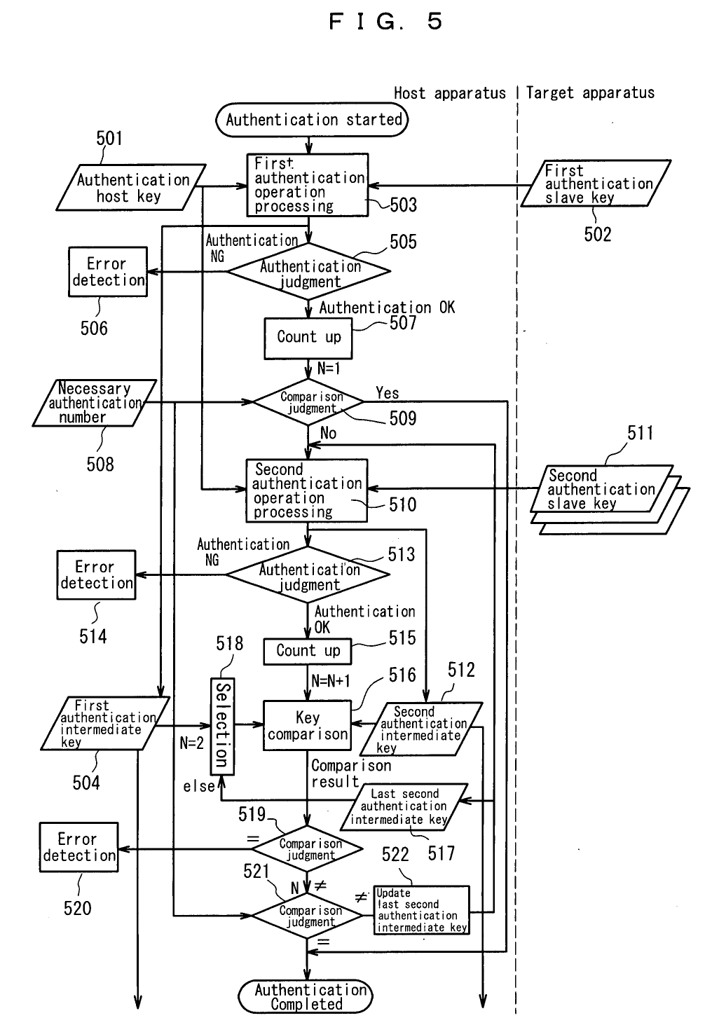

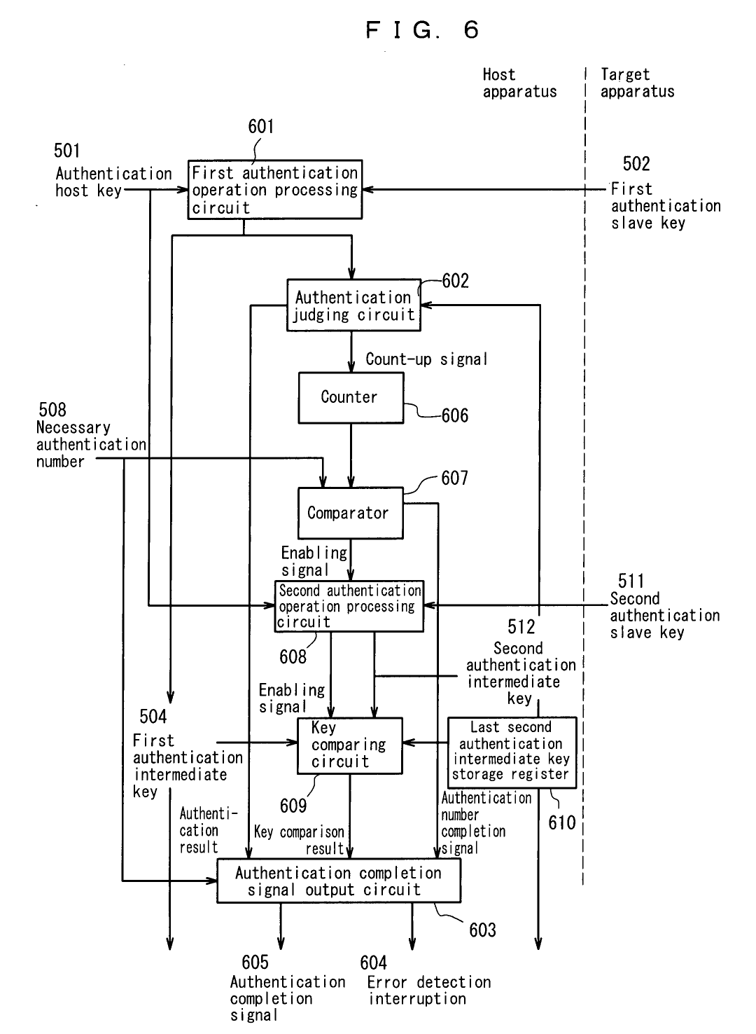

### BRIEF DESCRIPTION OF THE DRAWINGS

[FIG. 1] A diagram showing the overall structure of a secret information processing system according to the present invention;

[FIG. 2] A flowchart of an authentication method according to a first embodiment of the present invention;

[FIG. 3] A diagram showing an example of a circuit that executes the authentication method according to the first embodiment of the present invention;

[FIG. 4] A diagram showing a circuit for re-encrypting a key according to the first embodiment of the present invention;

[FIG. 5] A flowchart of an authentication method according to a second embodiment of the present invention;

[FIG. 6] A diagram showing an example of a circuit which executes the authentication method according to the second embodiment of the present invention;

[FIG. 7] A flowchart of a conventional authentication method;

[FIG. 8] A flowchart in decrypting the encrypted contents;

[FIG. 9] A flowchart in encrypting the contents; and

[FIG. 10] A diagram showing the state where secret information is stored in a target apparatus.

### DESCRIPTION OF REFERENCE NUMERALS

101 Target apparatus
102 Host apparatus
103 Bus
104 Target I/F part
105 Secret information processing part
106 HOST CPU
107 Host I/F part
108 RAM
201, 501 Authentication host key
202, 502 First authentication slave key
204, 504 First authentication intermediate key
211, 511 Second authentication slave key
212, 512 Second authentication intermediate key
301, 601 First authentication operation processing circuit
302, 602 Authentication judging circuit
303, 603 Authentication completion signal output circuit
304, 604 Error detection interruption
305, 605 Authentication completion signal
306, 606 Counter
307, 607 Comparator
308, 608 Second authentication operation processing circuit
309, 609 Key comparing circuit
401 Selector
402, 407 Encrypted contents key
403 Decrypting circuit
404 Contents key
405 Encrypting circuit
406 Another second authentication intermediate key
1001 First area
1002 Second area
1003 Third area

### BEST EMBODIMENT FOR CARRYING OUT THE INVENTION

### First Embodiment

A first embodiment as the best embodiment for carrying out the present invention will be described referring to the accompanying drawings. FIG. 1 shows the overall structure of a secret information processing system that is constituted with a host apparatus and a target apparatus.

A target apparatus 101 is a memory card such as an SD card as representation, to which data containing secret information is stored. As details of storing the data are the same as those shown in FIG. 10, the descriptions thereof are omitted. A host apparatus 102 connects to the target apparatus 101 so as to perform reading/writing of the secret information between the target apparatus 101.

The host apparatus 102 comprises: an internal bus 103; a target I/F part 104 for inputting/outputting data between itself and the target apparatus 101; a secret information processing part 105 that performs authentication between itself and the target apparatus, and encryption/decryption of the secret information according to a prescribed sequence; a host CPU 106 for starting the prescribed sequence to the secret information processing part 105; a host I/F part 107 for inputting/outputting data between the target apparatus 101, the secret information processing part 105 and the host CPU 106; and a RAM 108 as a work area where the host CPU 106 and the secret information processing part 105 temporarily store the data for the operations thereof.

It is necessary to perform authentication between the target apparatus 101 and the host apparatus 102, when the secret information is read out/written between the target apparatus 101 and the host apparatus 102. There, the secret information processing part 105 is started by the host CPU 106 to perform authentication processing.

When the authentication is succeeded, the host apparatus 102 reads out the secret information from the target apparatus via the target I/F part 104. The read out secret information is used through being encrypted with the use of the secret information processing part 105.

The activation of the secret information processing part 105 is executed with the host CPU 106. The secret information processing part 105 is concealed hardware that performs only a prescribed sequence where a security is established or a security is almost unnecessary, when it is started up.

FIG. 2 is a diagram showing a flowchart of the authentication method according to the embodiment of the present invention. When the authentication processing is started, the host apparatus executes first authentication operation processing 203, through handling an authentication host key 201 of the host apparatus and a first authentication slave key 202 read out from the target apparatus as the input. The first authentication operation processing 203 is the processing constituted with a plurality of functions including a one-way function. It is also the processing where the first authentication intermediate key 204 is generated when the authentication is succeeded, and a value “0” is generated when the authentication is failed. When the first authentication operation processing 203 is ended, the generated first authentication intermediate key 204 or the value “0” is stored in the authentication intermediate key storage area within the secret information processing part 105, and authentication judgment 205 is carried out. In the authentication judgment 205, it is judged whether or not the output of the first authentication operation processing 203 is “0”. When it is judged as “0”, the host apparatus considers that it is an unlawful access and drives the authentication (206) into failure, and discontinues the subsequent processing.

When the authentication in the first authentication operation processing 203 is succeeded, the first authentication intermediate key 204 is generated. Thereafter, count-up 207 is executed to increment the count value of the counter within the secret information processing part 105 so as to set the count value of the counter as “1”.

After incrementing the count value of the counter, the host apparatus performs comparison judgment 209 between the necessary authentication number 208 and the count value of the counter. If the necessary authentication number 208 is “1”, the current count value of the counter is equivalent to the necessary authentication number 208. Thus, it is considered unnecessary to execute the second authentication operation processing 210, and the authentication is completed.

If the necessary authentication number 208 and the count value of the counter are not equal, the second authentication processing 210 needs to be executed. In the second authentication operation processing 210, the processing 210 is carried out within the host apparatus, through handling the authentication host key 201 included in the host apparatus and a second authentication slave key 211 read out from the target apparatus as the input. The second authentication operation processing 210 is the processing constituted with a plurality of functions including a one-way function. It is the processing where a second authentication intermediate key 212 is generated when the authentication is succeeded, and a value “0” is generated when the authentication is failed. The second authentication operation processing 210 is also the processing that drives the authentication between the violated authentication host key and the second authentication slave key provided anew in the target apparatus into failure, when the authentication host key 201 is violated, and authorizes the authentication between another authentication key that is not violated and the second authentication slave key.

When the second authentication operation processing 210 is ended, the generated second authentication intermediate key 212 or the value “0” is stored in the authentication intermediate key storage area, and authentication judgment 213 is carried out. In the authentication judgment 213, it is judged whether or not the output of the second authentication operation processing 210 is “0”. When it is judged as “0”, the host apparatus considers that it is an unlawful access and drives the authentication (214) into failure, and discontinues the subsequent processing.

When the authentication in the second authentication operation processing is succeeded, the second authentication intermediate key 212 is generated. Thereafter, count-up 215 is executed to increment the count value of the counter held by the host apparatus so as to set the count value of the counter as “2”.

After incrementing the count value of the counter, the host apparatus performs comparison judgment 216 between the necessary authentication number 208 and the count value of the counter. If the necessary authentication number 208 is “2”, it is identical to the current count value of the counter. Thus, the procedure is advanced to the next step. When the necessary authentication number 208 and the count value of the counter are not identical, it is considered as an error and the processing is ended (217) since the maximum number of authentication times supposed in this embodiment is “2”.

When the necessary authentication number 208 and the current count value of the counter are identical, the value of the generated first authentication intermediate key 204 and the value of the second authentication intermediate key 212 are compared (218) in order to judge whether or not the first authentication intermediate key 204 and the second authentication intermediate key 212 are equal (219). When the value of the first authentication intermediate key 204 and the value of the second authentication intermediate key 212 are equal though they are supposed to be different, since it is considered that the authentication is being attempted in an unlawful way, the authentication flow is ended (220) presuming that an error is detected. When the value of the first authentication intermediate key 204 and the value of the second authentication intermediate key 212 are different, the host apparatus considers that the authentication is succeeded, thereby the authentication processing is ended. Through this procedure, the authentication flow between the host apparatus and the target apparatus is ended, and the host apparatus can perform decryption or the like of the encrypted contents stored in the target apparatus.

FIG. 3 is a diagram of a circuit for performing authentication within the secret information processing part 105 in the host apparatus to which the above-described authentication method is mounted. In FIG. 3, the same reference numerals are applied to the same structural elements as those of FIG. 1 and FIG. 2, and the descriptions thereof are omitted. The structure shown in FIG. 3 is concealed within the semiconductor integrated circuit as hardware. That is, the sequence of the processing cannot be changed by an access or the like from the host CPU. The authentication intermediate keys and the like generated during the authentication processing are all stored in the authentication intermediate key storage area (register) within the secret information processing part 105. However, those are not shown in the drawing.

The host apparatus executes the first authentication operation processing in a first authentication operation processing circuit 301, through handling the authentication host key 201 and the first authentication slave key 202 of the target apparatus as an input in order to generate the first authentication intermediate key 204. The host apparatus judges in an authentication judging circuit 302 whether or not the authentication operation processing is succeeded, through handling the first authentication intermediate key 204 as the input. Specifically, it is judged whether or not the value of the first authentication intermediate key 204 is “0”. The authentication result is outputted to an authentication completion signal output circuit 303.

When the value of the first authentication intermediate key 204 is “0”, the authentication completion signal output circuit 303 outputs an error detection interruption 304 and ends the processing. Even if the value of the first authentication intermediate key 204 is not “0”, an authentication completion signal 305 is not outputted because an authentication number completion signal has not been received yet.

When the value of the first authentication intermediate key 204 is not “0”, i.e. the authentication is succeeded, the authentication judging circuit 302 outputs a count-up signal to a counter 306. The counter 306 increments the count value as “1”, and outputs it to a comparator 307. The comparator 307 compares the necessary authentication number 208 and the count value.

When the necessary authentication number 208 is “1” and the count value of the counter 306 is equal to the necessary authentication number 208, the comparator 307 does not output an enabling signal to a second authentication operation processing circuit 308. Thus, the second authentication operation processing 210 is not executed. Meanwhile, the authentication number completion signal is outputted to the authentication completion signal output circuit 303.

The necessary authentication number 208 is also inputted to the authentication completion signal output circuit 303. When the necessary authentication number 208 is “1”, the authentication completion signal output circuit 303 that has received the authentication number completion signal outputs the authentication completion signal 305.

When the necessary authentication number 208 is not “1” and the count value of the counter 306 is not equal to the necessary authentication number 208, the comparator 307 outputs an enabling signal to the second authentication operation processing circuit 308 and executes the second authentication operation processing 210. The host apparatus executes the second authentication operation processing 210, through handling the authentication host key 201 and the second authentication slave key 211 read out from the target apparatus as the input for the second authentication operation processing circuit 308, in order to generate a second authentication intermediate key 212. The host apparatus inputs the second authentication intermediate key 212 to the authentication judging circuit 302 so as to judge whether or not the second authentication operation processing 210 is succeeded. Specifically, it is judged whether or not the value of the second authentication intermediate key 212 is “0”. The authentication result is outputted to the authentication completion signal output circuit 303. When the authentication result indicates that the authentication is failed, the authentication completion signal output circuit 303 outputs the error detection interruption 304.

When the value of the second authentication intermediate key 212 is not “0”, i.e. when the authentication is succeeded, the authentication judging circuit 302 outputs a count-up signal to the counter 306. The counter 306 increments the count value as “2”, and outputs it to the comparator 307. The comparator 307 compares the necessary authentication number 208 and the count value.

When the necessary authentication number 208 is not “2”, the comparator 307 outputs a compared number error signal to the authentication completion signal output circuit 303 because the maximum number of times of authentication presumed in this embodiment is “2”. When the compared number error signal is inputted, the authentication completion signal output circuit 303 outputs the error detection interruption 304 and ends the processing.

When the necessary authentication number 208 is “2” and the count value of the counter 306 is equal to the necessary authentication number 208, the comparator 307 outputs an enabling signal to a key comparing circuit 309, and outputs authentication number completion signal to the authentication completion signal output circuit 303.

The necessary authentication number 208 is also outputted to the authentication completion signal output circuit 303. When the necessary authentication number is “2”, the authentication completion signal output circuit 303 does not output the authentication completion signal 305 until the key comparison result from the key comparing circuit 309 is inputted, even in the case where the authentication number completion signal has been received.

Upon receiving an input of the enabling signal, the key comparing circuit 309 performs comparison to check whether or not the first authentication intermediate key 204 and the second authentication intermediate key 212 are identical, and outputs the key comparison result to the authentication completion signal output circuit 303.

When the key comparison result outputted from the key comparing circuit 309 indicates that the first authentication intermediate key 204 and the second authentication intermediate key 212 are identical, the authentication completion signal output circuit 303 outputs the error detection interruption 304 and ends the processing. Meanwhile, when the key comparison result outputted from the key comparing circuit 309 indicates that the first authentication intermediate key 204 and the second authentication intermediate key 212 are different, the authentication completion signal output circuit 303 outputs the authentication completion signal 305 to authorize the authentication.

As described above, when the necessary authentication number 208 is “1”, the authentication completion signal output circuit 303 considers that the authentication is succeeded upon receiving the authentication number completion signal, and ends the authentication. Further, when the necessary authentication number 208 is “2”, the authentication completion signal output circuit 303 considers that the authentication is succeeded upon receiving both the authentication number completion signal and the key comparison result indicating that the two keys are different, and ends the authentication.

That is, the security is enhanced by employing such a structure that the authentication is not authorized until the authentication is carried out for the necessary number of times through counting the authentication number to compare with the necessary authentication number. Further, when the necessary number of times of authentication is twice, the generated authentication intermediate keys are compared so that the authentication is not succeeded by the use of the same authentication slave key.

FIG. 4 is a diagram of a re-encryption circuit that re-encrypts the encrypted contents key with another second authentication intermediate key when the authentication is succeeded, and the re-encryption circuit is mounted inside the secret information processing part 105 of the host apparatus. Re-encryption is the processing that is carried out when the authentication host key is violated and the second authentication slave key is updated.

In FIG. 4, the same reference numerals are applied to the same structural elements as those of FIG. 2, and the descriptions thereof are omitted.

When the second authentication intermediate key 212 is generated, the host apparatus selects the second authentication intermediate key 212 through a selector 401 and, if not, selects the first authentication intermediate key 204, the host apparatus handles it as the selected authentication intermediate key. The host apparatus reads out an encrypted contents key 402 which is encrypted in advance with the selected authentication intermediate key and stored in the target apparatus, and decrypts it in a decrypting circuit 403 with the selected authentication intermediate key so as to obtain a plain contents key 404. The contents key 404 is re-encrypted by an encrypting circuit 405 with another second authentication intermediate key 406 that is different from the selected authentication intermediate key. Another second authentication intermediate key 406 is generated in carrying out authentication by using the updated authentication slave key when the authentication host key is violated and the second authentication slave key is updated. The encrypted contents key 407 after re-encryption is stored in the target apparatus by overwriting the encrypted contents key 402.

In the first embodiment, the processing is not ended unless the authentication operation processing is carried out the necessary number of times through counting the authentication number. Further, by comparing the second authentication intermediate key 212 generated in the second authentication operation processing 210 and the value of the first authentication intermediate key 204 generated in the first authentication processing 203 in the key comparing circuit 309, it is possible to avoid success of an unlawful authentication between the target apparatus having the information of the violated authentication host key 201 and the host apparatus having the violated authentication host key 201. Further, it is possible to safely carry out re-encryption of the encrypted contents key, which is performed when the authentication host key 201 is violated.

### Second Embodiment

A second embodiment of the present invention will be described referring to the accompanying drawings. In the second embodiment, since the overall structure of the secret information processing system is the same as that of the first embodiment, the description thereof is omitted.

FIG. 5 is an illustration showing a flowchart of the authentication method according to the second embodiment. The second embodiment is largely different from the first embodiment in the respect that the target apparatus comprises a plurality of second authentication slave keys and the host apparatus can execute the authentication operation processing three times or more.

When the authentication processing is started, the host apparatus executes first authentication operation processing 503, through handling an authentication host key 501 of the host apparatus and a first authentication slave key 502 read out from the target apparatus as the input. The first authentication operation processing 503 is the processing constituted with a plurality of functions including a one-way function. It is also the processing where a first authentication intermediate key 504 is generated when the authentication is succeeded, and a value “0” is generated when the authentication is failed.

When the first authentication operation processing 503 is ended, the generated first authentication intermediate key 504 or the value “0” is stored in the authentication intermediate key storage area in the host apparatus, and authentication judgment 505 is carried out. In the authentication judgment 505, it is judged whether or not the output of the first authentication operation processing 503 is “0”. When it is judged as “0”, the host apparatus considers that it is an unlawful access and drives the authentication (506) into failure, and discontinues the subsequent processing.

When the authentication in the first authentication operation processing 503 is succeeded, count-up is executed (507) to increment the count value of the counter held by the host apparatus to set the count value of the counter as “1”.

After incrementing the count value of the counter, the host apparatus performs comparison judgment 509 between the necessary authentication number 508 and the count value of the counter. If the necessary authentication number 508 is “1”, the current count value of the counter is equal to the necessary authentication number 508. Thus, it is considered unnecessary to execute the second authentication operation processing 510, and the authentication is completed.

If the necessary authentication number 508 and the count value of the counter is not equal, the second authentication processing 510 needs to be executed. In the second authentication operation processing 510, the host apparatus reads out one of a plurality of second authentication slave keys 511 included in the target apparatus. Then, the host apparatus carries out the second authentication operation processing 510, by handling the read out second authentication slave key 511 and the authentication host key 501 as the input. The second authentication operation processing 510 is the processing constituted with a plurality of functions including a one-way function. It is the processing where a second authentication intermediate key 512 is generated when the authentication is succeeded, and a value “0” is generated when the authentication is failed. The second authentication operation processing 510 is also the processing that drives the authentication between the violated authentication host key and the second authentication slave key arranged anew in the target apparatus into failure, when the authentication host key 501 is violated, and makes a success of the authentication between another authentication key that is not violated and the second authentication slave key.

When the second authentication operation processing 510 is ended, the generated second authentication intermediate key 512 or the value “0” is stored in the authentication intermediate key storage area, and authentication judgment 513 is carried out. In the authentication judgment 513, it is judged whether or not the output of the second authentication operation processing 510 is “0”. When it is judged as “0”, the host apparatus considers that it is an unlawful access and drives the authentication (514) into failure, and discontinues the subsequent processing.

When the authentication in the second authentication operation processing 510 is succeeded, count-up is executed (515) to increment the count value of the counter within the secret information processing part 105 so as to set the count value of the counter as “2”.

After incrementing the count value of the counter, the host apparatus performs key comparison 516. In the key comparison 516, the host apparatus selects either the first authentication intermediate key 504 or the last second authentication intermediate key 517 (518), and compares it with the second authentication intermediate key 512. When the count value of the counter is “2”, the host apparatus selects the first authentication intermediate key 504, and compares it with the second authentication intermediate key. When the count value of the counter is other than “2”, the host apparatus selects the second authentication intermediate key 517 that is the one before, and compares it with the second authentication intermediate key 512.

When the key comparison 516 is ended, it is judged whether or not the two compared keys are equal (519). When the values of the two authentication intermediate keys, which are supposed to be different, are equal, the authentication flow is ended (520) considering that an error is detected because it is thought that the authentication is being attempted in an unlawful way. When the values of the two authentication intermediate keys are different, the necessary authentication number 508 and the count value of the counter are compared again (521).

When the current value of the counter is equal to the necessary authentication number 508, the host apparatus considers that the authentication operation processing is executed the necessary number of times, and ends the authentication. If not, the host apparatus returns to the second authentication operation processing 510 to execute the next second authentication operation processing by using a second authentication slave key that is different from the second authentication slave key used in the first-time second authentication operation processing. At that time, the second authentication intermediate key 512 generated in the previous authentication is updated as the last second authentication intermediate key (522). As a result, in the second authentication operation processing, the second authentication intermediate key generated in the first time and the second authentication intermediate key generated in the second authentication operation processing of the second time are compared by the key comparison 516.

Through repeating the above-described processing by changing the second authentication slave key until the necessary authentication number 208 and the count value of the counter become equal, an arbitrary number of second authentication operation processing can be carried out to complete the authentication. When the authentication is completed, the host apparatus can perform decryption or the like of the encrypted contents stored in the target apparatus.

FIG. 6 is a diagram of a circuit for performing authentication within the secret information processing part provided in the host apparatus to which the above-described authentication method is mounted. In FIG. 6, the same reference numerals are applied to the same structural elements as those of FIG. 5, and the descriptions thereof are omitted. Further, the structure shown in FIG. 6 is concealed within the semiconductor integrated circuit as hardware. That is, the sequence of the processing cannot be changed by an access or the like from the host CPU. The authentication intermediate keys and the like generated during the authentication processing are all stored in the authentication intermediate key storage area (register) within the secret information processing part 105. However, those are not shown in the drawing.

The host apparatus executes the first authentication operation processing 503 in a first authentication operation processing circuit 601, by handling the authentication host key 501 and the first authentication slave key 502 read out from the target apparatus, in order to generate the first authentication intermediate key 504. The host apparatus judges in an authentication judging circuit 602 whether or not the authentication operation processing 503 is succeeded, by handling the first authentication intermediate key 504 as the input. Specifically, it is judged whether or not the value of the first authentication intermediate key 504 is “0”. The authentication result is outputted to an authentication completion signal output circuit 603.

When the value of the first authentication intermediate key 504 is “0”, the authentication completion signal output circuit 603 outputs an error detection interruption 604 and ends the processing since the authentication result indicates “failure”. Even if the authentication result indicates “success”, an authentication completion signal 605 is not outputted because an authentication number completion signal has not been received yet.

When the value of the first authentication intermediate key 504 is not “0”, i.e. the authentication is succeeded, the authentication judging circuit 602 outputs a count-up signal to a counter 606. The counter 606 increments the count value as “1”, and outputs it to a comparator 607. The comparator 607 compares the necessary authentication number 508 and the count value.

When the necessary authentication number 508 is “1” and the count value of the counter 606 is equal to the necessary authentication number 508, the comparator 607 does not output an enabling signal to a second authentication operation processing circuit 608, and the second authentication operation processing 510 is not executed. Meanwhile, the authentication number completion signal is outputted to the authentication completion signal output circuit 603.

When the inputted necessary authentication number 508 is “1”, the authentication completion signal output circuit 603 outputs the authentication completion signal 605 so as to succeed the authentication upon receiving the authentication number completion signal.

When the necessary authentication number 508 is not “1” and the count value of the counter 606 is not equal to the necessary authentication number 508, the comparator 607 outputs an enabling signal to the second authentication operation processing circuit 608 to start the second authentication operation processing circuit 510. The host apparatus executes the second authentication operation processing 510 in order to generate a second authentication intermediate key 512 by handling the authentication host key 501 and the second authentication slave key 511 read out from the target apparatus as the input to the second authentication operation processing circuit 608. The generated second authentication intermediate key 512 is inputted to the authentication judging circuit 602 and also stored in the last second authentication intermediate key storage register 610. The second authentication operation processing circuit 608 outputs an enabling signal to the key comparing circuit 609 so as to start the action thereof.

The authentication judging circuit 602 judges whether or not the second authentication operation processing 510 is succeeded based on the value of the inputted second authentication intermediate key 512. Specifically, it is judged whether or not the value of the second authentication intermediate key 512 is “0”. The authentication result is outputted to the authentication completion signal output circuit 603. When the authentication is failed, the authentication completion signal output circuit 603 outputs an error detection interruption 604.

When the value of the second authentication intermediate key 512 is not “0”, i.e. when the authentication is succeeded, the authentication judging circuit 602 outputs a count-up signal to the counter 606. The counter 606 increments the count value as “2”, and outputs it to the comparator 607. The comparator 607 compares the necessary authentication number 508 to the count value.

When the necessary authentication number 508 is “2” and the count value of the counter 606 is equal to the necessary authentication number 508, the comparator 607 outputs the authentication number completion signal to the authentication completion signal output circuit 603. When the necessary authentication number 508 is not “2” and the count value of the counter 606 is not equal to the necessary authentication number 508, the authentication number completion signal is not outputted, and an enabling signal is outputted again to the second authentication operation processing circuit 608. Then, the second authentication operation processing circuit 608 performs the second authentication operation processing by using a second authentication slave key that is different from the second authentication slave key used in the second authentication operation processing of the first time. The second authentication intermediate key generated in the second authentication operation processing of the first time is stored in the last second authentication intermediate key storage register. At that time, the second authentication intermediate key stored in the last second authentication intermediate key register 610 and the second authentication intermediate key generated in the second authentication operation processing of the second time are compared in the key comparing circuit 609 and then overwritten.

The key comparing circuit 609, to which the enabling signal is inputted, performs comparison to check whether or not the first authentication intermediate key 504 and the second authentication intermediate key 512 are identical, when the count value of the counter 606 is “2”. When the count value of the counter 606 is larger than “2”, the key comparing circuit 609 performs key comparison between the second authentication intermediate key stored in the last second authentication key storage register and the second authentication intermediate key outputted from the second authentication operation processing circuit. The key comparison result is outputted to the authentication completion signal output circuit 603.

When the key comparison result indicates that the values of the two authentication intermediate keys are identical, the authentication completion signal output circuit 603 outputs the error detection interruption 604 and ends the processing.

When the necessary authentication number 508 is “2” or more, the authentication completion signal output circuit 603 outputs the authentication completion signal 605 at the stage where the key comparison result in the number of times that is smaller by 1 than the value indicated by the necessary authentication number 508 and the authentication number completion signal are received.

The re-encryption circuit, which re-encrypts the encrypted contents key with another second authentication intermediate key after the authentication is succeeded, is the same as that of the first embodiment. Thus, the description thereof is omitted.

In the second embodiment, when the necessary authentication number 508 is “1”, the authentication completion signal output circuit 603 considers upon receiving the authentication number completion signal that the authentication is succeeded, and ends the authentication. Further, when the necessary authentication number 508 is “2” or more, the authentication completion signal output circuit 603 considers that the authentication is succeeded upon receiving both the authentication number completion signal and the key comparison result indicating that the number is smaller by 1 than the necessary authentication number, and ends the authentication.

That is, the security is enhanced by employing a structure where the authentication is not succeeded unless the authentication is carried out necessary number of times through counting the authentication number and comparing with the necessary authentication number. Further, the generated authentication intermediate keys are compared successively so that the authentication is not succeeded through using the same authentication slave key.

For executing the authentication in an arbitrary number of times, the compared number error signal described in the first embodiment is not used in this embodiment. However, when the upper limit is set for the number of authentication times, for example, the comparator 607 may output the compared number error signal if the authentication of more than that number is carried out.

Further, an enabling signal may be outputted from the comparator as in the case of the first embodiment.

### MODIFICATION EXAMPLE

Both the first and second embodiments are described as the structure where the number of authentications is counted, and it is compared with the necessary authentication number held in the host apparatus. However, considering that one authentication intermediate key is generated per authentication operation processing, the host apparatus may hold the number of necessary authentication intermediate keys in stead of the necessary authentication number, and compare it with the number of authentication times. Alternatively, the number of the authentication intermediate keys themselves may be counted and compared with the necessary authentication number.

Further, although the authentication operations are executed by providing a first authentication operation processing circuit and a second authentication operation processing circuit separately, a single authentication operation processing circuit may be used repeatedly.

Furthermore, it is more preferable that the necessary number of times for authentication be encrypted and then kept in the host apparatus, in terms of the security.

### INDUSTRIAL APPLICABILITY

The present invention is an authentication method to prevent an authentication from succeeding by unlawful procedure between the target apparatus having the information of the violated authentication host key and the host apparatus having the violated authentication host key. Thus, the present invention can improve the security, and it can be used in electronic distributions and the like.

1. An authentication method executed between a target apparatus and a host apparatus, comprising steps of:
a first step for generating an authentication intermediate key by carrying out an authentication operation based on an authentication host key included in said host apparatus and an authentication slave key included in said target apparatus;
a second step for judging whether or not authentication is succeeded in accordance with a value of said authentication intermediate key; and
a third step for counting how many times said second step has been carried out every time said second step is completed, wherein
said steps from said first step to said third steps are repeatedly executed until number of times counted in said third step reaches a prescribed value.

2. The authentication method according to claim 1, wherein said prescribed value is information regarding number of authentication times necessary to be carried out until authentication is succeeded.

3. The authentication method according to claim 1, wherein said prescribed value is information regarding number of authentication intermediate keys necessary to be generated until authentication is succeeded.

4. The authentication method according to claim 1, wherein said third step is carried out only when it is judged that authentication is succeeded as a result of performing said second step.

5. The authentication method according to claim 4, further comprising a forth step which compares said authentication intermediate key generated in said first step of N-th time (N is an integer of a prescribed value or smaller) and said authentication intermediate key of N−1 th time, when said prescribed value is 2 or larger, wherein
when it is judged that two authentication intermediate keys are equal as a result of performing said fourth step, subsequent authentication processing is not allowed to be executed.

6. The authentication method according to claim 4, wherein authentication is made to succeed when said third step is completed once in cases where said prescribed value is 1.

7. A re-encryption method which re-encrypts secret information stored in said target apparatus when authentication is succeeded through carrying out two or more times of authentication operation processing by employing said authentication method according to claim 1, said re-encryption method comprising steps of:
a fifth step for reading out an encrypted contents key from said target apparatus;
a sixth step for decrypting said encrypted contents key by using a prescribed authentication intermediate key so as to obtain a plain contents key; and
a seventh step for re-encrypting said plain contents key with an authentication intermediate key that is different from said prescribed authentication intermediate key.

8. A secret information processing host apparatus which carries out authentication processing between a target apparatus, comprising:
a first interface part which inputs and outputs secret information containing said encrypted contents between a target apparatus;
a secret information processing part which performs decryption processing to encrypted contents inputted via said first interface with a prescribed sequence set in advance; and
a CPU for instructing said secret information processing part to start said prescribed sequence, wherein
said secret information processing part comprises:
an authentication host key;
an authentication operation processing circuit which generates an authentication intermediate key through performing authentication operation processing by using said authentication host key and an authentication slave key that is stored in said target apparatus;
an authentication judging circuit for judging whether or not authentication is succeeded in accordance with a value of said authentication intermediate key; and
a counter for counting number of judgments carried out in said authentication judging circuit, wherein
a value of said counter is compared with a prescribed value, and authentication processing performed in said authentication operation processing circuit is repeated over a plurality of times until said values become identical.

9. The secret information processing host apparatus according to claim 8, further comprising a key comparing circuit which compares values of authentication intermediate keys that are generated when said authentication operation processing circuit performs a plurality number of times of authentication operation processing.

10. The secret information processing host apparatus according to claim 8, wherein, when said authentication processing is succeeded, said secret information processing part:
reads out encrypted contents key from said target apparatus;
decrypts said encrypted contents key by using a prescribed authentication intermediate key so as to obtain a plain contents key; and
re-encrypts said plain contents key with an authentication intermediate key that is different from said prescribed authentication intermediate key.
